(19) United States
(12) Patent Application Publication
(10) Pub. No.: US 2021/0144108 A1
(43) Pub. Date: May 13, 2021

(54) AUTOMATED USER-SUPPORT

(71) Applicant: Hewlett-Packard Development Company, L.P., Spring, TX (US)

(72) Inventors: Shameed Sait M A, Bangalore (IN); Niranjan Damera Venkata, Chennai (IN)

(21) Appl. No.: 17/050,959

(22) PCT Filed: Aug. 2, 2018
(86) PCT No.: PCT/US2018/045003

§ 371 Date: Oct. 27, 2020

(51) Int. Cl. H04L 12/58; G06F 16/9032; G06F 16/9038; G06F 16/9535; G06F 11/34; G06N 20/00

(52) U.S. Cl. CPC H04L 51/02; G06F 16/90332; G06N 20/00; G06F 16/9535; G06F 11/3438; G06F 16/9038

(57) ABSTRACT

Examples for providing automated user support are described herein. In an example, a query that a user is seeking to resolve is determined, based on real-time tracking of multi-modal inputs from the user on a user-support system. For the query, a resolution is provided to the user from a resolution database to provide automated user-support.

### BACKGROUND

On a daily basis, large number of users facing queries while using appliances and devices, such as printers and laptops, seek troubleshooting help. Generally, user-support portals, such as web portals, allow such users to raise requests to seek help with their devices. Once a request, referred to as a ticket, is raised on the user-support portal, a support agent may be assigned to the ticket. Thereafter, the support agent can communicate with the user, understand the query, and guide the user to fix the query.

### BRIEF DESCRIPTION Of FIGURES

The detailed description is provided with reference to the accompanying figures, wherein:

FIG. 1 illustrates an example of a network environment employing a query resolution system to provide automated user-support, according to an example;

FIG. 2 illustrates an example of the query resolution system to provide automated user-support, according to an example;

FIG. 3 illustrates a detailed schematic of the query resolution system to provide automated user-support, according to an example;

FIG. 4 illustrates a method to provide automated user-support, according to an example.

FIG. 5 illustrates a detailed method to provide automated user-support, according to an example.

FIG. 6 illustrates a network environment to provide automated user support, according to an example.

It should be noted that the description and the figures are merely examples of the present subject matter and are not meant to represent the subject matter itself. Throughout the drawings, identical reference numbers designate similar, but not identical, elements. The figures are not to scale, and the size of some parts may be exaggerated to more clearly illustrate the example shown. Moreover, the drawings provide examples and/or examples consistent with the description; however, the description is not limited to the examples and/or examples provided in the drawings.

### DETAILED DESCRIPTION

Generally, user-support portals, such as web portals, are provided for users to raise requests to seek technical support. When the user raises a request, referred to as a ticket, on the user-support portal, a support agent may get in touch with the user and assist the user in resolving the query. In other cases, when looking for troubleshooting assistance, users may, first, perform a cursory search on the user-support portal, in order to resolve the query on their own. For instance, the queries may be common queries, such as paper jams in a printer or quality of scanned images in a scanner. Resolutions for such common queries, for example, clearing the paper jam or removing dust from scanner glass, can be easily performed be performed by the user if the user is provided with the knowledge of troubleshooting steps.

To assist the user in finding a resolution, there may be support options, such as automated chatbots, which automatically come forth on support webpages. However, such options are often intrusive, and a lot of context has to be provided to by the user. Additionally, if the user is unable to verbalize the query to such automated options, the user experience may be worsened by such an interaction, where, for instance, the user may painstakingly type out the details of the query and the automated option may be unable to understand the query or may be unable to provide adequate support. Accordingly, when the users are unable to quickly find a solution, they may proceed and raise a ticket. Once the ticket has been raised, as part of user support, a support agent has to be assigned to look into the query. In other words, even easily fixable problems may involve a support agent, because the user may be unable to find, a solution from the support portal, making this a labour-intensive exercise and leading to high operational cost.

Approaches for providing automated user-support are described. According to an aspect, the approaches involve determining, in an automated manner, a query that a user may be seeking to resolve and, then, providing a resolution for the query to the user. In an example, the user may be in the process of seeking an appropriate solution, for instance, on a user support portal. However, in another case, the user may be browsing the content instead of finding a solution. The present subject matter involves determining whether the user is performing a troubleshooting action and seeking a solution, or performing a non-troubleshooting action, such as browsing.

Accordingly, the present subject matter may involve monitoring, in real-time, activity of the user through a plurality of modes on a user-support system, such as a web-based user support portal. The plurality of modes through which the user-activity can be monitored may include, for example, number of mouse clicks made by the user on the user-support system, average time spent on the user-support system, and search phrases used on the user-support system. By tracking the user inputs, referred to as multi-modal inputs, from such various modes on the user-support system, the query that the user may be seeking assistance for can be identified. Therefore, in simple words, multi-modal inputs can include inputs provided by the user to the user-support system, as a result of various activities or interactions of the user with the user-support system. As mentioned above, in an example, first an intention of the user, in terms of troubleshooting actions and non-troubleshooting actions may be determined, again, based on the multi-modal inputs from the user. Once the query has been identified, a resolution for the query can be provided to the user.

In an example, the resolution can be identified from a resolution database to provide automated user-support. In said example, after the query has been identified, the query may be checked against a list of queries which can be resolved with high confidence without assistance from a support agent. If the identified query is in that list, the steps to resolve that query are retrieved and provided to the user, prior to the user raising the ticket. The user may, then, perform the steps or may be automatically navigated through the steps, to resolve the query, without any assistance from support personnel.

Therefore, the present subject matter supports a user in resolving a query without the user having to raise a ticket, by automatically analyzing whether the query can be solved without assistance from support personnel and provides the resolution to the user in such situations. Accordingly, the present subject matter can enable fewer support tickets being raised, thereby ensuring that a small support personnel team may have to be maintained for assigning and catering to the support tickets, while other queries can be resolved remotely or by the user. As a result, a cost of operation may be low and may also allow for effective management of resources in terms of time and labour. In addition, by circumventing the entire process of ticket generation and assignment of support personnel for assistance, the present subject matter may allow for an expedited resolution of queries. Accordingly, the user experience may be enhanced.

The above aspects are further described in conjunction with the figures, and in associated description below. It should be noted that the description and figures merely illustrate principles of the present subject matter. Therefore, various arrangements that encompass the principles of the present subject matter, although not explicitly described or shown herein, may be devised from the description and are included within its scope. Additionally, the word “coupled” is used throughout for clarity of the description and can include either a direct connection or an indirect connection.

FIG. 1 illustrates a network environment 100 employing, a query resolution system 102 for providing automated user-support, according to an example. For example, a user may be seeking resolution for a query, and the query resolution system 102, in response, can provide a solution to the user in the form an automated support, without involving human-intervention in the form of support personnel for resolving the query. In an example, the network environment 100 can include a support server 104. Further, the support server 104 may be communicatively coupled over a network 106 to a plurality of user devices 108-1. 108-2, . . . 108-N, collectively referred to as user devices 108 and individually referred to as user device 108. The user devices 108 may be employed as any of a variety of computing devices, including, servers, a desktop personal computer, a notebook or portable computer, a workstation, a mainframe computer, a mobile computing device, a laptop, a mobile phone, or any other hand-held computing device. In another example, various user devices 108 may be employed as a part of a single device, for example, by virtualization.

In an example, the support server 104 may be employed as any of a variety of computing devices, including, servers, a desktop personal computer, a notebook or portable computer, a workstation, a mainframe computer, a mobile computing device, and a laptop. Further, in one example, the support server 104 may itself be a distributed or centralized network system in which different computing devices may host the hardware components, the software components, or a combination thereof, of the support server 104. For instance, the support server 104 may host a user-support portal that the user may have access to through the respective user device 108 to raise a query to resolve the solution. Accordingly, each user device 108 may behave as a user-support system 108 and the user may communicate with the support server 104 using the user-support system 108. For instance, the user-support system 108 can have a browser-based access to the user support portal or may have an application for accessing the user-support functionality on the support server 104. Hereinafter, the user device(s) 108 are interchangeably referred to as user-support system(s) 108.

The support server 104 may, in turn, be communicatively coupled to the query resolution system 102, the query resolution system 102 also being communicatively coupled to the user-support systems 108. Though the query resolution system 102 is illustrated in FIG. 1 as being directly coupled to the support server 104, the query resolution system 102 may employ the network 106 for connecting to the support server 104. As the support server 104, the query resolution system 102 may be employed as any of a variety of computing devices, including, servers, a desktop personal computer, a notebook or portable computer, a workstation, a mainframe computer, a mobile computing device, and a laptop. Further, in one example, the query resolution system 102 may itself be a distributed or centralized network system in which different computing devices may host components, the software components, or a combination thereof, of the query resolution system 102.

As mentioned previously, the query resolution system 102 may provide automated user-support to users querying the support server 104 for resolving requests, technical or otherwise. The query resolution system 102 may be further coupled to a resolution database 110 that serves as a repository of knowledge where the query, resolution system 102 can find a resolution to the query raised by the user. In an example, the resolution database 110 can include a case log library that may store case logs created by different user-support systems 108 for resolving a variety of queries encountered in the past. The case log may be a record of observations of all the historical resolution steps for resolving the query along with the record as to whether each of the resolution steps worked in resolving the query or not, and whether each sequence of resolution steps resolved the query or not. The case log may also include an indication if the resolution steps were executed by the user. In addition, the resolution database 110 can include a standard resolution library that may store standard resolution steps for each the plurality of queries. The query resolution system 102 can be coupled to the resolution database 110 over the network 106.

The network 106 may be a wireless network, a wired network, or a combination thereof. The network 106 can also be an individual network or a collection of many such individual networks, interconnected with each other and functioning as a single large network, e.g., the Internet or an intranet. The network 106 can be employed as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 106 may include network devices, such as network switches, hubs, routers, for providing a link between the query resolution system 102, the support server 104, and the user-support systems 108, and can also include communication links for the communication between the various components in the network environment 100. The communication links between the query resolution system 102, the computing devices 104, 108, 110, and the databases may be enabled through any form of communication, for example, via dial-up modem connections, cable links, digital subscriber lines (DSL), wireless or satellite links, or any other suitable form of communication.

In operation, as mentioned previously, the query resolution system 102 can, in an automated manner, provide a solution to a query by a user, based on two factors—first, on an intent of the user for using the user-support system 108 and, secondly, on accurate identification of the query. For example, as part of assessing the intent of the user, the query resolution system 102 can determine as to whether or not the use of the user-support system 108 suggests a behavior that is indicative of the user attempting to resolve the query or, at least seeking a resolution for the query. Once the intent has been established, the query resolution system 102 can further identify the query that the user is seeking to resolve, again, for instance, based on a manner of use of the user-support system 108 by the user. The operation of the query resolution system 102 in providing automated user-support is explained further detail with reference to the following figures.

FIG. 2 illustrates a schematic of the query resolution system 102 to provide automated user-support, according to an example. As shown in FIG. 2, the query resolution system 102 may include, for example, engines 202. The engines 202 may be employed as a combination of hardware and programming (for example, programmable instructions) to use functionalities of the engines 202. In examples described herein, such combinations of hardware and programming may be used in a number of different ways. For example, the programming for the engines 202 may be processor executable instructions stored on a non-transitory machine-readable storage medium and the hardware for the engines 202 may include a processing resource (for example, processors), to execute such instructions. In the present examples, the machine-readable storage medium stores instructions that, when executed by the processing resource, deploy engines 202. In such examples, the query resolution system 102 may include the machine-readable storage medium storing the instructions and the processing resource to execute the instructions, or the machine-readable storage medium may be separate but accessible to query resolution system 102 and the processing resource. In other examples, engines 202 may be deployed using electronic circuitry. The engines 202 may include a tracking engine 204 and a user-assistance engine 206.

In an example, the tracking engine 204 can observe, in real-time, activity of a user on the user-support system 108 through a plurality of modes. For instance, the activity can be observed on a usage of a peripheral device associated with the user-support system 108, on a time spent by the user on the user-support system 108, or in other similar ways. Such observations of the interactions of the user with the user-support system 108 are referred to as multi-modal inputs by the user, where an interaction of the user may be in the form of an input to the user-support system 108. The real-time observation can be, for example, tracking an activity that the user is performing on the user-support system 108 at any instant. In other words, real-time observation can include identifying an instantaneous act being performed by the user on the user-support system 108.

Based on the real-time observing, the tracking engine 204 may determine or assess a behavior of the user in relation to performing the activity. For example, the tracking engine 204 may attempt to determine the intention of the user while employing the user-support system 108 as to whether the user is seeking to resolve a query or not. In response to determining or assessing the behavior, the tracking engine 204 may identify the query that the user is seeking to resolve. The tracking engine 204 may identify the query based on the observed behavior of the user. Once the query has been identified, the user-assistance engine 206 may, then, identify a resolution for the query from the resolution database 110 for providing automated user-support to the user. The manner by which the query resolution system 102 operates will be explained with respect to FIG. 3 onwards.

FIG. 3 illustrates a detailed schematic of the query resolution system 102, showing various components of the query resolution system 102, according to an example. The query resolution system 102, among other things and in addition to the engines 202, can include a memory 302 having data 304, and interface(s) 306. The engines 202, among other capabilities, may fetch and execute computer-readable instructions stored in the memory 302. The memory 302, communicatively coupled to the engines 202, may include a non-transitory computer-readable medium including, for example, volatile memory, such as Static Random Access Memory (SRAM) and Dynamic Random Access Memory (DRAM), and/or non-volatile memory, such as Read-Only-Memory (ROM), erasable programmable ROM, flash memories, hard disks, optical disks, and magnetic tapes.

In an example, in addition to the tracking engine 204 and the user-assistance engine 206, the engines 202 may include other engine(s) 308. The other engine(s) 308 may provide functionalities that supplement applications or functions performed by the query resolution system 102. Further, the tracking engine 204 can include a translation engine 310.

In addition, the data 304 includes data that is generated as a result of the functionalities carried out by any of the engines 202. The data 304 may include observation data 312, query resolution data 314, and other data 316. The other data 316 may include data generated and saved by the engines 202 to provide various functionalities to the query resolution system 102.

As explained previously, in operation, the query resolution system 102, based on real-time behavior of the user on the user-support system 108, can determine whether the user is intending to resolve a query, and if so, determine a subject associated with the query that the user is seeking to resolve. The term “real-time”, as an example, may indicate a temporal event that occurs at a given instant or a given period and which is observed at substantially the same instant or substantially for the same period as the instant or period of occurrence. For instance, the observation may not occur at the same instant as that of the occurrence of the event, with due consideration to delays due to operation and latency in the various computing systems and devices, such as the query resolution system 102, the user-support systems 108, the support server, and the resolution database 110, and/or the network 106.

To that effect, the tracking engine 204 can, as mentioned previously, in real-time, track multi-modal inputs of the user on the user-support system 108. In an example, the multi-modal inputs can be the various interactions of the user with the user-support system 108 through various modes. In one example, one mode of input can be through a peripheral device, such as mouse, associated with the user-support system 108, in which case, the tracking engine 204 can track a number of clicks or a frequency of clicks or both that the user performs on the mouse in a given period of observation. Alternately or in addition, the tracking engine 204 may also track the kind of links that the user clicks on. For instance, if the user clicks on links, having keywords such as “how to”, “fix”, “not working”, or “troubleshoot”, or synonyms thereof, and the frequency of clicking is high, the tracking engine 204 may take that to indicate that the user is frantically searching for a resolution to a query. In the same example, another mode of input can be based on a time spent by the user on the user-support system 108. For instance, in case the user-support system 108 is used to access a web-based support portal and the user navigates through various webpages of the portal, the tracking engine 204 can track the time spent by the user on each webpage of the portal which forms an input of the user in the present mode. Further, yet another mode of input can be search keyword entered or input by the user on the web-based support portal on the user-support system 108, which can be tracked and observed by the tracking engine 204 as part of tracking the multi-modal user inputs. For instance, the tracking engine 204 may also track a frequency of search keywords being input by the user which can be used for assessing the behavior of the user. Any of the aforementioned modes of inputs, referred to as multi-modal inputs, and in any combination, may be used by the tracking engine 204. For tracking the multi-modal inputs, the tracking engine 204 may employ various techniques and modules in the user-support system 108 to obtain the data associated with the multi-modal inputs from the user-support system 108. The tracking engine 204 may save the data regarding the multi-modal inputs in the observation data 312.

Further, based on the real-time tracking and observation, the tracking engine 204 may attempt to assess the behavior of the user while performing the activity of providing multi-modal inputs to the user-support system 108. In other words, the tracking engine 204 may attempt to determine whether the user is seeking to resolve, a query or not, using the multi-modal inputs and employing machine learning techniques on the multi-modal inputs. In an example, the tracking engine 204 may employ supervised learning techniques for training and deploying the machine learning model. In another example, however, the tracking engine 204 may employ non-supervised learning techniques for training and deploying the machine learning model.

In an example, the tracking engine 204 may incorporate and employ the machine learning techniques at two levels; first, in a training phase of a machine learning model where the machine learning model is fed the data associated with the multi-modal inputs, and second, in an operation phase, where the trained machine learning model may be employed as a tool for assessing or predicting the behavior of the user from new real-time or instantaneous multi-modal inputs from the user.

In the example above, in the training phase, the tracking engine 204 incorporating the machine learning model can be trained using the data of the multi-modal inputs from the user stored in the observation data 312. In one case, each observation in the set of the multi-modal inputs may undergo a process of feature conversion where the observation may be converted into a machine understandable format. For instance, a pattern of multi-modal inputs by the user including the frequency of clicks and the links that are clicked is tracked by the tracking engine 204, and then converted each pattern or observation into a vector or a numeric representation. Further, each such converted representation is associated with a tracking label. In one example the tracking label can indicate a conclusive action or a behavior associated with the observation. In another example, the tracking label may be a probabilistic indicator as to an action or a behavior associated with the observation. In yet another example, the tracking label may also be indicative of a type of the action. For instance, the tracking label may indicate whether the action is a troubleshooting action that may indicate the behavior associated with the action of intending to resolve a query, or the tracking label may indicate a non-troubleshooting action which may indicate the behavior associated with the action is that the user is not intending to resolve a query.

In addition, in the training phase, the tracking engine 204 may be trained to identify a query that the user is seeking to resolve, when the behavior indicates an intention to resolve a query, based on the multi-modal inputs observed and tracked by the tracking engine 204. For example, in a similar manner as described above, the tracking engine 204 can first convert the observation into a machine-understandable representation, and then associate each representation with a query label indicative, either conclusively or probabilistically, of a query associated with that observation. For example, the observation of based on one of the modes of input of the user regarding the search phrase being typed in the user-support system 108 can be parsed and can be associated with a query. In another example, when the type of links that the user clicks on the user-support system 108 can be an observation that can be associated with a query. In yet another example, the webpage on which the user spends most time on the user-support system 108 during the duration of observation can be associated with a query. The observation, the converted representation of the observation, the tracking label, and the query label, if any, associated with the observation can all be linked to each other stored in the observation data 312.

Once the tracking engine 204 is trained, in the operation phase, the translation engine 310 can use the data stored in the observation data 312 for assessing the observed multi-modal inputs or the behavior of the user in relation to the user-support system 108 to conclusively determine whether the user is intending to resolve the query or not. Subsequently, the tracking engine 204 can determine the query that the user is seeking to resolve, based on the observed behavior of the user.

In an example, as part of understanding the behavior and classifying the activities performed through various modes of input on the user-support system 108, the translation engine 310 may first translate the observed activity of the user into actions. The translation engine 310 may employ the information stored by the tracking engine 204 in the observation data 312 for performing such translation. For instance, the translation engine 310 can convert the activity or the multi-modal input observed in real-time for the user into a machine-readable form, for example, in a mathematical representation. The translation engine 310 can then match the converted representation against the previously stored representations in the observation data 312 to determine the action or actions associated with the multi-modal inputs or activities performed by the user.

Once the activities have been translated into actions, the translation engine 310 can then segregate the actions into troubleshooting actions and non-troubleshooting actions, using machine learning techniques, and use the segregated data set of actions to determine the intention of the user as to whether the user is looking to resolve a query or not. In an example, the translation engine 310 may employ the predictive machine learning model trained, as explained previously, by the tracking engine 204, for segregating the actions into troubleshooting actions and non-troubleshooting actions. Again, the translation engine 310 may make use of the tracking labels stored in the observation data 312, associated with observations, to segregate the actions between troubleshooting actions and non-troubleshooting actions. The translation and segregation done by the translation engine 310 is explained with reference to the following example, for ease of understanding.

For instance, if the user is simply browsing the webpage on the support portal on the user-support system 108 without clicking on any links for a predefined period of time, the real-time observation by the tracking engine 204 can be “no clicks”. In such a case, the translation engine 310 can match the real-time observation, converted into a mathematical representation, such as a vector or a numerical value, against the previously stored representations in a similar format in the training phase. For instance, the translation engine 310, using machine learning techniques explained above, can attempt to predict the action that the real-time observation represents. In other words, the translation engine 310 can attempt to predict the action that the real-time observation, based on the historical data and the tracking label, would indicate. In the above case, where the observation is “no clicks”, the translation action 310 may translate the observation into an action termed as “browsing”. In other words, when the frequency of clicking by the user is low, the tracking engine 204 can categorize that as a situation where the user is not seeking to resolve a query. Further, based on tracking label, the translation engine 310 can also determine that the action “browsing” is associated with a tracking label that indicates that as a non-troubleshooting action. In such a case, the translation engine 310 may indicate to the query resolution system 102 that the user is not intending to resolve a query and the tracking engine 204 may be prompted to continue tracking the activity of the user through the multiple modes.

On the other hand, when the translation engine 310 indicates that the action of the user is indicative of a behavior showing intention to resolve a query, which means that the action of the user is categorized as a troubleshooting action, then the tracking engine 204 is to identify the query that the user is seeking to resolve, based on that troubleshooting action. In an example, the tracking engine 204 may employ the machine learning techniques and in the manner as explained previously, on the multi-modal inputs to identify the query that the user is seeking to resolve. Therefore, in this case also, i.e., for identifying the query based on the multi-modal inputs based on machine learning techniques, as mentioned previously, the tracking engine 204 may be trained in the training phase and then may perform the identification in the operation phase, based on the training. Therefore, as explained previously, by the end of the training phase, the tracking engine 204 may have a repository of observations linked with the query label that is indicative, either conclusively or probabilistically, of a query associated with that observation. Accordingly, using the machine learning model, the tracking engine 204 can identify the query that the user is seeking to resolve, The tracking engine 204 may store the identified query in the query resolution data 316.

Once the query has been identified by the tracking engine 204, the user-assistance engine 206 may, then, identify a resolution for the query from the resolution database 110. Since the entire process of assessing the behavior of the user, identifying the query, and then finding a resolution for the query is devoid of any human intervention, the query resolution system 102 is said to be providing automated user-support.

For facilitating the user-assistance engine 206 in identifying the resolution for the identified query, in an example, similar to the tracking engine 204, the user-assistance engine 206 can also employ supervised or non-supervised learning techniques. Accordingly, the user-assistance engine 206 can employ a machine learning model which is, first, trained and then employed by the user-assistance engine 206. In said example, the training phase and operation phase of the user-assistance engine 206 is performed in the same manner as explained previously with respect to the training and operation of the tracking engine 204.

In the training phase of the machine learning model employed by the user-assistance engine 206, data from the resolution database 110 may be fed to the user-assistance engine 206 and that data may be associated with resolution labels, In the operation phase, the user-assistance engine 206 may employ the trained machine learning model for predicting the resolution to the query from the resolution database. For instance, the user-assistance engine 206 incorporating the machine learning model can be trained using the case log library and the standard resolution library in the resolution database 110, both providing an insight on the historically raised queries and their respective resolutions. In one case, each observation in the set of the multi-modal inputs may undergo a process of feature conversion where the observation may be converted into a machine understandable format. For instance, the user-assistance engine 206 can convert each observation into a vector or a numeric representation. Further, each such converted representation is associated with a query and, then, a resolution label which may indicate, conclusively or probabilistically, a resolution associated with the query. The information regarding the observation, the associated query, and the resolution may be provisionally stored in the query resolution data 314.

For example, the machine learning model may be trained to behave as a predictive model to predict, in probabilistic terms, the applicability of a resolution for the identified query. Accordingly, in said example, the user-assistance engine 206 may identify a predetermined number of resolutions by matching the identified query that the user is seeking to resolve and the existing queries in the resolution database 110. For instance, the matching may be performed based on the query data saved in the query resolution data 314 which is nothing but an image of the data in the resolution database 110. In an example, the queries that match beyond a threshold value are determined as a positive match and the resolution labels associated with the positive matches are identified from the query resolution data 314. Accordingly, a resolution associated with each of the resolution labels may be retrieved from the resolution database 110. In other words, the user-assistance engine 206 may identify a predetermined number of resolutions, based on a threshold match between the determined query and existing queries in the resolution database 110. The user may then be provided with the identified predetermined number of resolutions to select and provide the selection to the user-assistance engine 206. The user-assistance engine 206 can, then, in return provide the automated user-support to the user based on the selected resolution.

In another example, however, the user-assistance engine 206 can, instead of identifying the predetermined number of resolutions, may identify a single resolution for the identified query, in the same manner as explained above. The user-assistance engine 206 can, then, identify a series of steps of the identified resolution based on a predictive model for navigating the user through the series of steps. For instance. once the resolution is identified, a list of resolution steps that may provide an appropriate resolution for the query may be predicted based on a knowledge representation, the knowledge representation being a collection of various unique resolution steps and relationships between all such unique resolution steps. In an example, the relationships between the unique resolution steps may be identified based on a probability of occurrence of next resolution steps with respect to a previous resolution step, for instance, using various stochastic modelling techniques, such as Hidden Markov Model, Baum-Welch algorithm, expectation-maximization algorithm.

Therefore, once the query is identified, the user-assistance engine 206 can identify a primary solution for the query based on the knowledge representation. In one example, the primary solution may include list of predicted resolution steps in order of highest probability of occurrence. In an example, the user-assistance engine 206 may deliver the predicted resolution steps along with documentation, such as videos, images, or text, that corresponds to each resolution step, to the user. For example, the documentation may be identified based on a match between the resolution step and a standard resolution step, the documentation being associated with the standard resolution step. In other cases, where there is no match, the predicted resolution step may still be presented without the link to the documentation. Accordingly, the user-assistance engine 206 may guide the user through predicted resolution steps to provide the resolution for the query. Also, in case a resolution step does not work, the user-assistance engine 206 may generate a new list of backup resolution steps to provide to the user. Therefore, in the present example as well as in the examples where the predetermined number of resolutions are identified form the resolution database 110, the user-assistance engine 206 may select the resolution from the resolution database 110 based on a degree of confidence associated with the resolution in resolving the query. In an example, the degree of confidence may be a parameter that may be associated with each resolution in the resolution database 110 at the time of building of the resolution database 110.

The identification of the query as performed by the tracking engine 204 and resolution identification by the user-assistance engine 206 is explained with reference to the following example, for ease of understanding.

The user may input the search string “paper stuck” or “print quality low” in the user-support system 108, which can be parsed by the tracking engine 204 and converted into a vector representation. The tracking engine 204 can then map the vector representation of the search string against a repository of vectors, such as a database of vectors of historically resolved queries, prepared during the training phase and stored in the observation data 312. In addition, the tracking engine 204, as part of the mapping, may also take into account the flow of behavior-to-query-to-resolution performed during the training phase. In other words, the tracking engine 204, while mapping, may take into account whether the query was correctly identified based on the tracked and assessed behavior, and the resolution was able to adequately resolve the query in the training phase. Further, when the resolution is identified, in the manner explained above, there might be a multi-class classification of the query, i.e., the same query may map with different kinds of previously stored queries, to various extents. For example, the same query “noisy printer” may map with “noise in the printer” and “low print quality”, but with different probabilities for one versus the other. In an example, the user-assistance engine 206 can, based on the higher of the two probabilities, predict the query and provide the resolution to the user. In another example, the user-assistance engine 206 may provide both the queries to the user and request selection, and based on the selection, may provide the resolution to the user. In yet another example, the user-assistance engine 206 can identify the resolutions for both the abovementioned queries and can provide both the resolutions to the user. Based on which match suits the user, the user may select the resolution and proceed with resolving the query.

FIG. 4 and FIG. 5 illustrate a method 500 for providing automated user-support, in accordance with an example of the present subject matter. While FIG. 4 illustrates the method 500 in brief, FIG. 5 illustrates the method 500 for providing automated user support in detail. The method(s) 400 may be described in the general context of computer executable instructions. Generally, computer executable instructions can include routines, programs, objects, components, data structures, procedures, engines, functions, etc., that perform particular functions or employ particular abstract data types. The method(s) 400 may also be practiced in a distributed computing environment where functions are performed by remote processing devices that are linked through a communications network. In a distributed computing environment, computer executable instructions may be located in both local and remote computer storage media, including memory storage devices.

The order in which the blocks in the method(s) 400 is described is not intended to be construed as a limitation, and any number of the described blocks can be combined in any order to employ the method(s) 400, or an alternative method. Additionally, individual blocks may be deleted from the method(s) without departing from the scope of the subject matter described herein. Furthermore, the method(s) 400 can be employed in any suitable hardware, software, firmware, or combination thereof The method(s) 400 is explained with reference to the query resolution system 102, and for the sake of brevity, the components and details associated with the method 400 described in FIG. 4 and FIG. 5 are not repeated. It will be understood that the method(s) 400 can be employed in other query resolution systems 102 as well.

Referring to method 400, at block 402, a query that a user is seeking to resolve is determined, based on real-time tracking of multi-modal inputs from the user on the user-support system 108. Based on the real-time tracking, a behavior of the user in relation to the multi-modal inputs can be assessed. For example, the intention of the user while employing the user-support system 108 as to whether the user is seeking to resolve a query or not may be determined.

In an example, real-time tracking can include observing an act being performed by the user on the user-support system 108 at any given instant or for a predetermined period. Further, in an example, the multi-modal inputs can be the various interactions of the user with the user-support system 108 through various modes. In one example, one mode of input can be through a peripheral device, such as mouse, associated with the user-support system 108, in which case, the tracking engine 204 can track a number of clicks that the user performs on the mouse in a given period of observation, In the same example, another mode of input can be based on a time spent by the user on the user-support system 108. For instance, in case the user-support system 108 is used to access a web-based support portal and the user navigates through various webpages of the portal, the tracking engine 204 can track the time spent by the user on each webpage of the portal which forms an input of the user in the present mode. Further, yet another mode of input can be search phrases entered by the user on the portal, which can be tracked and observed by the tracking engine 204 as part of tracking the multi-modal user inputs.

At block 404, a resolution for the query is provided from a resolution database 110 to the user to provide automated user-support to the user.

As mentioned previously, FIG. 5 illustrates a detailed method 400 for providing automated user-support, according to an example of the present subject matter.

Referring to block 502, user inputs through multiple modes on the user-support system 108 are monitored. The user inputs through multiple modes, also referred to multi-modal inputs, have been described earlier in detail with reference to block 402. Based on the real-time tracking and observation, a behavior of the user while performing the activity of providing multi-modal inputs to the user-support system 108 may be assessed as to whether the user is seeking to resolve a query or not.

At block 504, user inputs are translated into actions, for instance, using a machine learning model. For example, the activity or the multi-modal input observed in real-time for the user can be converted into a machine-readable form, such as in a mathematical representation. Then, the converted representation can be matched against the previously stored representations stored during training phase of the machine learning model, to determine the action or actions translated based on the multi-modal inputs or activities performed by the user.

At block 506, actions are segregated into troubleshooting actions and non-troubleshooting actions, using machine learning techniques. The segregated data set of actions may be used to determine the intention of the user as to whether the user is looking to resolve a query or not. In an example, predictive machine learning model trained previously is employed for segregating the actions into troubleshooting actions and non-troubleshooting actions. For instance, tracking labels stored in the observation data 312 during the training phase of the machine learning model and associated with observations, may be used to segregate the actions between troubleshooting actions and non-troubleshooting actions.

At block 508, for troubleshooting actions, the query that the user is seeking to resolve is determined, based on the monitored multi-modal inputs from the user on the user-support system 108, using machine learning techniques. In an example, the machine learning techniques may be employed, as explained previously, based on a repository of observations linked with the query label that is indicative, either conclusively or probabilistically, of a query associated with that observation, the repository prepared in the training phase of the machine learning model. Accordingly, using the machine learning model, the query that the user is seeking to resolve can be identified.

At block 510, in response to the determining at block 508, a resolution, having high confidence for resolving the determined query, is identified for the query from the resolution database 110. In an example, the machine learning model may be trained to behave as a predictive model to predict, in probabilistic terms, the applicability of a resolution for the identified query. Accordingly, in said example, a predetermined number of resolutions may be identified by matching the determined query and existing queries in the resolution database 110. In an example, the queries that match beyond a threshold value are determined as a positive match, and a resolution associated with each of the positive matches may be retrieved from the resolution database 110. In other words, a predetermined number of resolutions may be identified as part of identifying the resolution to the query, based on a threshold match between the determined query and existing queries. The user may then be provided with the identified predetermined number of resolutions to select the appropriate resolution that matches the query, according to the user. In another example, instead of identifying the predetermined number of resolutions, a single resolution may be identified for the query, in the same manner as explained in the previous example, for instance, based on the threshold match.

At block 512, the resolution is provided to the user as part of providing automated user-support. According to one instance of the present subject matter, in the above examples, whether the resolution is finally selected by the user or is automatically identified, subsequently, a series of steps of the resolution can be determined based on a predictive model to navigate the user. For instance, once the resolution is identified, a list of resolution steps that may provide an appropriate resolution for the query may be predicted based on a knowledge representation, the knowledge representation being a collection of various unique resolution steps and relationships between all such unique resolution steps. In an example, the relationships between the unique resolution steps may be identified based on a probability of occurrence of next resolution steps with respect to a previous resolution step, for instance, using various stochastic modelling techniques, such as Hidden Markov Model, Baum-Welch algorithm, expectation-maximization algorithm.

Therefore, once the query is identified, a primary solution for the query may be identified based on the knowledge representation. In one example, the primary solution may include list of predicted resolution steps in order of highest probability of occurrence. In an example, the predicted resolution steps may be delivered along with documentation, such as videos, images, or text, that corresponds to each resolution step, to the user. For example, the documentation may be identified based on a match between the resolution step and a standard resolution step, the documentation being associated with the standard resolution step. In other cases, where there is no match, the predicted resolution step may still be presented without the link to the documentation. Accordingly, the user may be guided through predicted resolution steps. As mentioned previously at block 510 also, the resolution may be selected based on a degree of confidence associated with the resolution in resolving the query. In an example, the degree of confidence may be a parameter that may be associated with each resolution in the resolution database 110 at the time of building of the resolution database 110.

In another example, where, at block 510 a resolution having high confidence is unavailable, then, at block 512, as part of providing the resolution, a human support agent can be involved who can assist the user in finding an appropriate resolution for the query.

FIG. 6 illustrates a network environment 600 using a non-transitory computer readable medium 602 to provide automated user-support, according to an example of the present subject matter. The network environment 600 may be a public networking environment or a private networking environment. In one example, the network environment 600 includes a processing resource 604 communicatively coupled to the non-transitory computer readable medium 602 through a communication link 606.

For example, the processing resource 604 may be a processor of a computing system, such as the query resolution system 102. The non-transitory computer readable medium 602 may be, for example, an internal memory device or an external memory device. In one example, the communication link 606 may be a direct communication link, such as one formed through a memory read/write interface. In another example, the communication link 606 may be an indirect communication link, such as one formed through a network interface. In such a case, the processing resource 604 may access the non-transitory computer readable medium 602 through a network 608. The network 608 may be a single network or a combination of multiple networks and may use a variety of communication protocols.

The processing resource 604 and the non-transitory computer readable medium 602 may also be communicatively coupled to data sources 610 over the network 608. The data sources 610 may include, for example, databases and computing devices. The data sources 610 may be used by the database administrators and other users to communicate with the processing resource 604.

In one example, the non-transitory computer readable medium 602 includes a set of computer readable and executable instructions, such as the tracking engine 204 and the user-assistance engine 206. The set of computer readable instructions, referred to as instructions hereinafter, may be accessed by the processing resource 604 through the communication link 606 and subsequently executed to perform acts for network service insertion.

For discussion purposes, the execution of the instructions by the processing resource 604 has been described with reference to various components introduced earlier with reference to description of FIG. 2 and FIG. 3.

On execution by the processing resource 604, the tracking engine 204 may differentiate between a troubleshooting action by the user and a non-troubleshooting action by the user, by monitoring, in real-time, activity of a user through a plurality of modes on a user-support system 108. The activity of the user on the user-support system 108 through the plurality of modes is referred to as multi-modal inputs of the user on the user-support system 108. In response to the action by the user being identified as a troubleshooting action, a query that the user is seeking to troubleshoot is identified, again based on the troubleshooting action. In an example, the tracking engine 204 may employ a trained machine learning model for identifying the query. Subsequently, once the query has been identified, a resolution for the query is provided to the user from a resolution database to provide automated user-support.

Although aspects for providing automated user-support have been described in a language specific to structural features and/or methods, it is to be understood that the subject matter is not limited to the features or methods described. Rather, the features and methods are disclosed as examples for providing automated user-support.

I/we claim:

1. A method comprising:
determining a query that a user is seeking to resolve, based on real-time tracking of multi-modal inputs from the user on a user-support system; and
providing a resolution for the query from a resolution database to the user to provide automated user-support.

2. The method as claimed in claim 1, wherein the determining comprises:
translating the multi-modal inputs into actions, and
segregating the actions into troubleshooting actions and non-troubleshooting actions, using machine learning techniques;
wherein the determining the query is based on the troubleshooting actions.

3. The method as claimed in claim 1, wherein the providing the resolution comprises:
identifying a predetermined number of resolutions, based on a threshold match between the determined query that the user is seeking to resolve and existing queries in the resolution database; and
receiving a selection of a resolution from amongst the predetermined number of resolutions to provide the automated user-support to the user.

4. The method as claimed in claim 1, wherein the providing the resolution comprises navigating the user through a series of steps, the series of steps being identified based on a predictive model.

5. The method as claimed in claim 1, wherein the multi-modal inputs comprise a number of clicks made by the user, a frequency of clicks made by the user, a time spent by the user on the user-support system, a search keyword input by the user in the user-support system, a frequency of input of the search keyword by the user or a combination thereof.

6. A query resolution system comprising:
a tracking engine to,
observe, in real-time through a plurality of modes, activity of user on a user-support system;
determine, based on the observing, behavior of the user n relation to performing the activity; and
identify, in response to the determining, a query that the user is seeking to resolve, based on the determined behavior; and
a user-assistance engine to identify a resolution for the query from a resolution database to provide automated user-support.

7. The query resolution system as claimed in claim 6, wherein the tracking engine is to:
translate the activity of the user, observed in real-time through the plurality of modes, into actions; and
segregate the actions into troubleshooting actions and non-troubleshooting actions, using machine learning techniques, to determine an intention of the user;
wherein the tracking engine is to identify the query that the user is seeking to resolve based on the troubleshooting actions.

8. The query resolution system as claimed in claim 6, wherein the user-assistance engine is to:
identify a predetermined number of resolutions, based on a threshold match between the identified query that the user is seeking to resolve and existing queries in the resolution database: and
receive a selection of a resolution from amongst the predetermined number of resolutions to provide the automated user-support to the user.

9. The query resolution system as claimed in claim 6, wherein the user-assistance engine is to:
identify a series of steps of the selected resolution based on a predictive model; and
navigate the user through the series of steps.

10. The query resolution system as claimed in claim 6, wherein the user-assistance engine is to select the resolution from the resolution database based on a degree of confidence associated with the resolution in resolving the query.

11. A non-transitory computer-readable medium comprising computer-readable instructions which, when executed by a processing resource, cause the processing resource to:
differentiate, by monitoring activity of a user through a plurality of modes on a user-support system in real-time, between a troubleshooting action by the user and a non-troubleshooting action by the user;
identify a query that the user is seeking to troubleshoot, based on the troubleshooting action; and
provide a resolution for the query from a resolution database to the user to provide automated user-support.

12. The non-transitory computer-readable medium as claimed in claim 11 to cause the processing resource to:
translate the activity of the user, observed in real-time through the plurality of modes, into actions; and
segregate the actions into troubleshooting actions and non-troubleshooting actions, using machine learning techniques, to assess a behavior of the user to identify the query that the user is seeking to resolve based on the troubleshooting actions.

13. The non-transitory computer-readable medium as claimed in claim 11 to cause the processing resource to:
identify a predetermined, number of resolutions, based on a threshold match between the identified query that the user is seeking to resolve and existing queries in the resolution database; and
receive a selection of a resolution from amongst the predetermined number of resolutions to provide the automated user-support to the user.

14. The non-transitory computer-readable medium as claimed in claim 11 to cause the processing resource to:
identify a series of steps of the resolution based on a predictive model; and
navigate the user through the series of steps.

15. The non-transitory computer-readable medium as claimed in claim 11 to cause the processing resource to select the resolution from the resolution database based on a degree of confidence associated with the resolution in resolving the query.
